(19) United States
(12) Patent Application Publication
(10) Pub. No.: US 2026/0199815 A1
(43) Pub. Date: Jul. 16, 2026

(54) SMART AIR PURIFIER AND A METHOD THEREOF

(71) Applicant: HCL Technologies Limited, New Delhi (IN)

(72) Inventors: Dipumon Ayyanchira Mani, Bengaluru (IN); Priya A Tembhare, Bengaluru (IN); Darshan Navnath Chavhan, Bengaluru (IN); Veera Manoharan Rajamannar, Bengaluru (IN)

(21) Appl. No.: 19/094,818

(22) Filed: Mar. 29, 2025

(30) Foreign Application Priority Data
Jan. 15, 2025 (IN) 202511003324

(51) Int. Cl. B01D 46/00; F24F 3/16

(52) U.S. Cl. CPC B01D 46/0005; F24F 3/16

(57) ABSTRACT

This disclosure relates to a smart air purifier and a method thereof. The air purifier includes a drive assembly configured to move a movable base along at least two vertical supports. The air purifier includes a filter assembly including a set of filters arranged telescopically within the structural frame. Topmost filter is movably coupled to the movable base. The air purifier includes a bellow coupled to the movable base. The bellow includes two distinguishable regions. When the movable base moves along the at least two vertical supports, based on direction of movement of the movable base, one of the two distinguishable regions is configured to expand and another is configured to retract. The air purifier includes a controller configured to cause the drive assembly to move the movable base based on an input signal received from at least one of air quality sensor or user device.

### TECHNICAL FIELD

This disclosure generally relates to air purifiers, and more particularly to a smart air purifier and a method thereof.

### BACKGROUND

Air pollution is posing a major risk to health and well-being of people around the world, especially in urban areas. Use of air purifiers is now very common in such areas. However, conventional air purifiers may lack in adaptability to different user environments that they may be deployed in (such as homes, offices and educational institutions, open outdoor areas, etc.). Additionally, the conventional air purifiers may lack in providing personalization based on user requirements (such as air quality, coverage area, operation and maintenance costs, airflow rate, etc.). For example, air purifiers generally used in a home environment may be required to provide good air quality, have more automation and maintenance features, and produce less noise while operating. On the other hand, air purifiers located in open areas of residential or industrial complexes may be required to provide a reasonable (i.e., moderate) air quality, but the operation and maintenance costs need to be low.

Thus, a user may need to select different air purifiers with features suitable to different user requirements. This may be highly inconvenient and cost-intensive for many users. Therefore, there is a need of a smart air purifier that adapts with the changing environments and is customizable as per the user requirements.

### SUMMARY

In an embodiment, an air purifier is disclosed. The air purifier may include a structural frame. The structural frame may include at least two vertical supports, and a movable base coupled to the at least two vertical supports. The air purifier may further include a drive assembly coupled to the structural frame. The drive assembly may be configured to move the movable base along the length of the at least two vertical supports. The air purifier may further include a filter assembly including a set of filters arranged telescopically within the structural frame. A top filter from the set of filters may be movably coupled to the movable base. The air purifier may further include a bellow coupled to the movable base. The bellow may include two distinguishable regions. Each of the two distinguishable regions may include one or more unique markers. When the movable base moves along the length of the at least two vertical supports, based on a direction of movement of the movable base, one of the two distinguishable regions may be configured to expand and another of the two distinguishable regions may be configured to retract. The air purifier may further include a controller communicatively coupled to the drive assembly. The controller may be configured to cause the drive assembly to move the movable base based on an input signal received from at least one of an air quality sensor or a user device.

In another embodiment, a method of air purification is disclosed. The method may include causing, by a controller, a drive assembly to move a movable base based on an input signal received from at least one of an air quality sensor or a user device. The controller may be communicatively coupled to the drive assembly. The drive assembly may be coupled to a structural frame. The drive assembly may be configured to move the movable base along a length of at least two vertical supports. The structural frame may include the at least two vertical supports, and the movable base coupled to the at least two vertical supports. A filter assembly including a set of filters may be arranged telescopically within the structural frame. A top filter from the set of filters may be movably coupled to the movable base. A bellow may be coupled to the movable base. The bellow may include two distinguishable regions. Each of the two distinguishable regions may include one or more unique markers. When the movable base moves along the length of the at least two vertical supports, based on a direction of movement of the movable base, one of the two distinguishable regions may be configured to expand and another of the two distinguishable regions may be configured to retract.

It is to be understood that both the foregoing general description and the following detailed description are exemplary and explanatory only and are not restrictive of the invention, as claimed.

### BRIEF DESCRIPTION OF THE DRAWING

The accompanying drawings, which are incorporated in and constitute a part of this disclosure, illustrate exemplary embodiments and, together with the description, serve to explain the disclosed principles.

FIG. 1 illustrates an exploded view of an exemplary air purifier, in accordance with some embodiments of the present disclosure.

FIG. 2A illustrates a perspective view of an exemplary air purifier in a low power operational mode, in accordance with an embodiment of the present disclosure.

FIG. 2B illustrates a sectional view of an exemplary air purifier in a low power operational mode, in accordance with an embodiment of the present disclosure.

FIG. 3A illustrates a perspective view of an exemplary air purifier in a moderate power operational mode, in accordance with an embodiment of the present disclosure.

FIG. 3B illustrates a sectional view of an exemplary air purifier in a moderate power operational mode, in accordance with an embodiment of the present disclosure.

FIG. 4A illustrates a perspective view of an exemplary air purifier in a high power operational mode, in accordance with an embodiment of the present disclosure.

FIG. 4B illustrates a sectional view of an exemplary air purifier in a high power operational mode, in accordance with an embodiment of the present disclosure.

FIG. 5 is a functional block diagram of an exemplary air purifier, in accordance with some embodiments of the present disclosure.

FIG. 6 is a flow diagram of an exemplary method of air purification, in accordance with some embodiments of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only, with the true scope being indicated by the following claims. Additional illustrative embodiments are listed.

Further, the phrases “in some embodiments”, “in accordance with some embodiments”, “in the embodiments shown”, “in other embodiments”, and the like, mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope and spirit being indicated by the following claims.

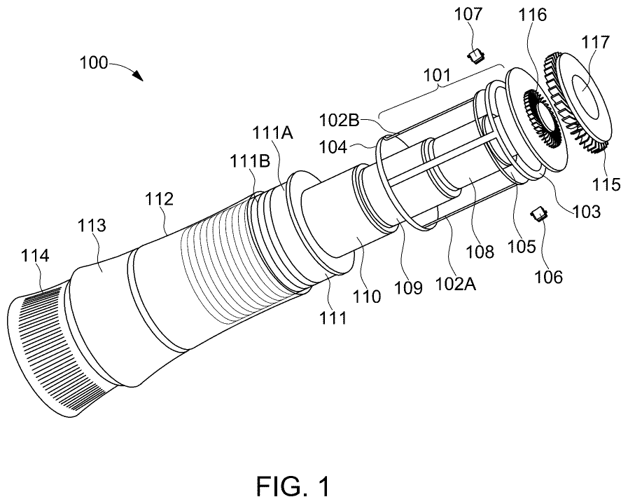

Referring now to FIG. 1, an exploded view of an exemplary air purifier 100 is illustrated, in accordance with some embodiments of the present disclosure. The air purifier 100 may include a structural frame 101. The structural frame 101 may include at least two vertical supports (such as the vertical support 102A and the vertical support 102B), each coupled to a top base 103 at a top end and a bottom base 104 at a bottom end. In a preferred embodiment, the structural frame 101 may include four vertical supports. For ease of explanation, two vertical supports are discussed in the foregoing embodiment. However, the principles of working described henceforth may be applied to any number of vertical supports equal to or more than two. Each of the top base 103 and the bottom base 104 may be stationary. The structural frame 101 may be of cylindrical shape, a cuboidal shape, a prism shape, or any polygonal cylinder shape. The shape of the structural frame 101 may be based on a number of the vertical supports and a shape of the bases. The structural frame 101 may further include a movable base 105. The movable base 105 may be coupled to each of the vertical support 102A and the vertical support 102B. It should be noted that the movable base 105 includes an inner periphery and an outer periphery.

Further, the air purifier 100 may include a drive assembly coupled to the structural frame. The drive assembly may include a rack and an associated guide (i.e., rail) mounted on each of the at least two vertical supports. Further, the drive assembly may include a motor 106 coupled to the rack and the associated guide of the vertical support 102A through a first gear. Additionally, drive assembly may include a motor 107 coupled to the rack and the associated guide of the vertical support 102B through a second gear. As will be appreciated, the rack and the associated guide, when coupled with a gear, may form a rack and pinion linear actuation system. The motor 106 and the motor 107 may provide a rotational force to the first gear and the second gear, respectively. The rotational force may case the first gear and the second gear to rotate about a plurality of teeth on the associated guides of the vertical support 102A and the vertical support 102B. This may cause the first gear and the second gear to move vertically (i.e., linearly) along the length of the vertical support 102A and the vertical support 102B, respectively.

The motor 106 and the motor 107 may also be coupled to the movable base 105. Thus, the drive assembly may be configured to move the movable base 105 along the length of the vertical support 102A and the vertical support 102B. The movable base 105 may move in an upward direction or a downward direction based on a direction of rotation of the motor 106 and the motor 107.

Further, the air purifier 100 may include a filter assembly including a set of filters arranged telescopically within the structural frame 101. In an embodiment, the set of filters may include a first filter 108, a second filter 109, and a third filter 110. The first filter 108 may be movably coupled to the movable base 105. In an embodiment, the first filter 108 is coupled to the inner periphery of the movable base 105. Based on a direction of movement of the movable base 105, the set of filters may telescopically expand or may telescopically retract. For example, a downward movement of the movable base 105 may cause a telescopic retraction of the set of filters. Similarly, an upward movement of the movable base 105 may cause a telescopic expansion of the set of filters. By way of an example, the first filter 108 may be an activated carbon filter, the second filter 109 may be an anti-bacterial filter, and the third filter 110 may be a true High Efficiency Particulate Arresting (HEPA) filter. Materials and compositions of the set of filters may vary based on manufacturer requirements.

Further, the air purifier 100 may include a bellow 111 coupled to the movable base 105. The bellow 111 may be coupled to the outer periphery of the movable base 105 from a center of the bellow 111. The bellow 111 may include two distinguishable regions (i.e., a first region 111A and a second region 111B). Each of the two distinguishable regions may include one or more unique markers. By way of an example, the one or more unique markers may include, but may not be limited to, colours, patterns, labels, and the like. In a preferred embodiment, the first region 111A and the second region 111B may include unique and distinguishable colours. In another embodiment, the first region 111A and the second region 111B may form a colour gradient where opposing ends of the first region 111A and the second region 111B have different unique colours.

When the movable base 105 moves along the length of the vertical support 102A and the vertical support 102B, based on a direction of movement of the movable base 105, one of the two distinguishable regions is configured to expand and another of the two distinguishable regions is configured to retract. For example, a downward movement of the movable base 105 causes an expansion of the first region 111A and a retraction of the second region 111B. An upward movement of the movable base 105 causes a retraction of the first region 111A and an expansion of the second region 111B.

In an alternative embodiment, the air purifier 100 may include a bellow assembly (not shown) coupled to the movable base 105. The bellow assembly may include two distinguishable bellows. Each of the two distinguishable bellows may include one or more unique markers (such as colours, patterns, labels, and the like). In such an embodiment, the two distinguishable bellows may be configured to expand in opposite directions when the movable base 105 moves along the length of the at least two vertical support 102A and the vertical support 102B. In other words, when a first bellow expands, a second bellow may retract based on the direction of movement of the movable base 105. For example, a downward movement of the movable base 105 may cause an expansion of the first bellow and a retraction of the second bellow. Similarly, an upward movement of the movable base 105 may cause a retraction of the first bellow and an expansion of the second bellow. To achieve the opposite expansion direction of the two bellows, the first bellow is coupled to the outer periphery of the movable base 105 from a bottom end of the first bellow. Additionally, the second bellow is coupled to the outer periphery of the movable base 105 from a top end of the second bellow.

Further, the air purifier 100 may include a housing 112 enclosing the structural frame 101, the drive assembly, the filter assembly, the bellow 111, and the controller. The housing 112 may be at least partially transparent. The one or more unique markers of the two distinguishable regions (i.e., the first region 111A and the second region 111B) are identifiable through the housing 112 by a user from outside.

Further, the air purifier 100 may include a pre-filter 113 and an inlet unit 114. The inlet unit 114 may be located at a first end of the housing 112 configured to draw air from an outer environment. The first end of the housing 112 may be a bottom end or a top end. The inlet unit 114 encloses the pre-filter 113 and at least one of the set of filters based on a position of the movable base 105.

Further, the air purifier 100 may include an outlet unit 115 in fluid communication with the inlet unit 114. The outlet unit may be located at a second end of the housing 112. The second end of the housing 112 may be opposite to the first end of the housing 112. In an embodiment, the outlet unit 115 may be in fluid communication with the inlet unit 114 through an airflow channel. The outlet unit 115 may be configured to receive filtered air from the inlet unit 114. Further, the outlet unit 115 may be configured to provide the filtered air to the outer environment. The outlet unit 115 may include an exhaust fan 116 positioned near an opening of the air flow channel. The exhaust fan 116 may draw the filtered air from the inlet unit 114 towards the outlet unit 115. This may create a vacuum in the inlet unit 114, allowing the inlet unit 114 to draw in more air from the outer environment for filtration.

Further, the air purifier 100 may include a controller (not shown) communicatively coupled to the drive assembly. The controller may be enclosed within the housing 112. In an embodiment, the controller may be positioned in the inlet unit 114. In an embodiment, the controller may be communicatively coupled to a digital display 117. The digital display 117 may be a touch display.

The controller may be configured to cause (through an electrical signal) the drive assembly to move the movable base 105 based on an input signal received from at least one of an air quality sensor or a user device. The air quality sensor may be located in the inlet unit 114 to monitor the quality of incoming air. The quality of the incoming air may be displayed in real-time on the digital display 117. The user device may be communicably connected to the controller via a communication network (such as Wi-Fi or Bluetooth®). In an embodiment, a user may provide the input signal through a Graphical User Interface (GUI) of an application on the user device.

The controller may process the input signal using an Artificial Intelligence (AI) algorithm to determine an operation mode from a set of predefined operation modes. By way of an example, the set of predefined operation modes may include a low power operation mode, a moderate power operation mode, and a high power operation mode. For each of the set of predefined operation modes, a predefined number of the set of filters is engaged in the inlet unit 114. Additionally, for each of the set of predefined operation modes, each of the first region 111A and the second region 111B of the bellow 111 is expanded at a predefined level. Further, in some embodiments, a speed of the exhaust fan 116 may also be predefined for each of the set of predefined operation modes to provide an appropriate airflow for each operation mode.

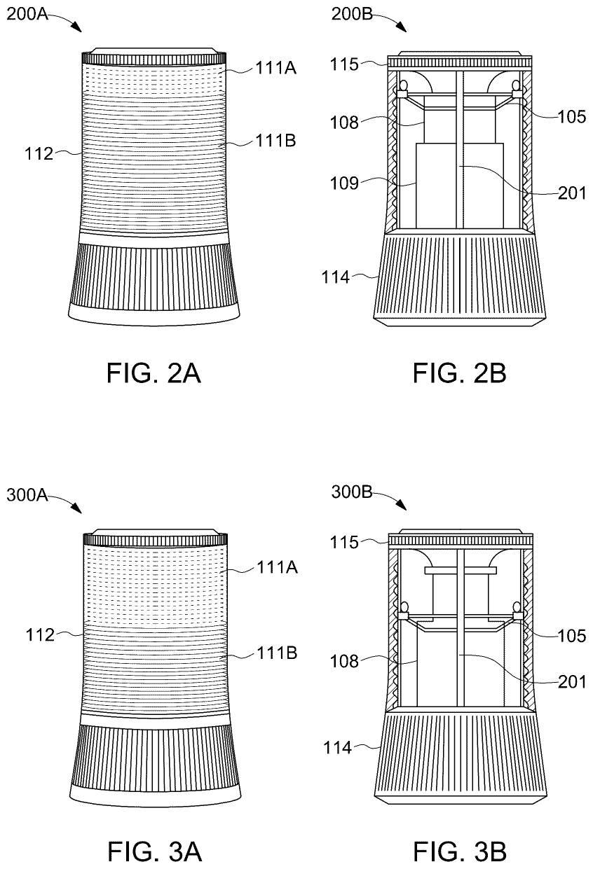

Further, based on the operation mode, the controller may cause the drive assembly to move the movable base 105 along the length of the vertical support 102A and the vertical support 102B. Based on the movement of the movable base 105, the predefined number of the set of filters corresponding to the operation mode may be engaged in the inlet unit 114. For each of the set of predefined operation modes, a predefined number of the set of filters is engaged in the inlet unit 114. The telescopic retraction of the set of filters increases a current number of the set of filters engaged in the inlet unit 114. The telescopic expansion of the set of filters decreases a current number of the set of filters engaged in the inlet unit 114. This is explained in greater detail in conjunction with FIGS. 2A-B, 3A-B, and 4A-B.

Additionally, based on the movement of the movable base 105, each of the first region 111A and the second region 111B of the bellow 111 may be moved to the predefined level corresponding to the operation mode. This is explained in greater detail in conjunction with FIGS. 2A-B, 3A-B, and 4A-B.

In some embodiments, the speed of the exhaust fan 116 may be adjusted dynamically, via the controller, based on real-time air quality data in an automatic mode of the air purifier. For example, the controller may cause an increase in the speed during high pollution periods and may cause a reduction in the speed when the air is cleaner to save energy. The speed of the exhaust fan 116 may also be controlled manually by the user either through the digital display 117 on the air purifier 100 or the application on the user device.

By way of an example, the AI algorithm may include, but may not be limited to, an Artificial Neural Network (ANN) model, a Recurrent Neural Network (RNN) model, a Long short-term memory (LSTM) model, or the like). The AI algorithm may determine an optimal operation mode for the air purifier 100 based on parameters such as, but not limited to, user preferences (such as energy efficiency, any other custom setting, etc.), Air Quality Index (AQI), user parameters (such as location, age group of family members (toddlers and senior citizens may require higher air quality), any family member with an air quality-related medical condition (such as asthma, allergy, etc.), or the like. In some alternative embodiments, the input signal may be processed by a conventional logic-based (or rule-based) algorithms to determine an operation mode from a set of predefined operation modes. Additionally, a user may be allowed to manually change the operation mode through the user device or through the digital display 117.

Referring now to FIG. 2A, a perspective view 200A of an exemplary air purifier (for example, the air purifier 100) in a low power operational mode is illustrated, in accordance with an embodiment of the present disclosure. FIG. 2A is explained in conjunction with FIG. 1. The low power operational mode may be an optimal operational mode in good to moderate air quality conditions (e.g., when AQI is in a range of about 0-100). The two distinguishable regions of the bellow 111 (i.e., the first region 111A and the second region 111B) are visible through the housing 112. In the low power operational mode, the first region 111A is in a retracted state whereas the second region 111B is in an expanded state. These retracted and expanded states of the first region 111A and the second region 111B, respectively, may be used to indicate to the user that the air purifier is currently running in the low power operation mode.

When the first region 111A and the second region 111B are distinguishable through a colour-based marker, the feedback (i.e., indication of the operation mode) may be in form of a colour-coded feedback. By way of an example, the first region 111A is blue coloured and the second region 111B is green coloured. For low power operation mode, (i.e., AQI range between 0-100), the colour-coded feedback may be shown as green because the first region 111A is in a retracted state whereas the second region 111B is in an expanded state.

Referring now to FIG. 2B, a sectional view 200B of an exemplary air purifier in a low power operational mode is illustrated, in accordance with an embodiment of the present disclosure. FIG. 2B is explained in conjunction with FIGS. 1 and 2A. In the low power operational mode, the movable base 105 is moved upwards by the drive assembly. The upward movement of the movable base 105 may cause the set of filters to telescopically expand. Thus, the first filter 108 (such as the activated carbon filter) and the second filter 109 (such as the antibacterial filter) may not be engaged in the inlet unit 114. Only the third filter 110 (such as the true HEPA filter) and the pre-filter 113 (not shown) may be engaged in the inlet unit 114. It should be noted that the third filter 110 may be telescopically retracted around the pre-filter 113 inside the inlet unit 114.

When the inlet unit 114 draws in air from the outer environment, the air may be filtered through the pre-filter 113 and the third filter 110. Further, the inlet unit 114 may transfer the filtered air to an airflow channel 201 due to a suction force applied by the exhaust fan 116 (not shown). The filtered air may pass through the airflow channel 201 and may reach the outlet unit 115, from where it may be released into the outer environment.

Referring now to FIG. 3A, a perspective view 300A of an exemplary air purifier in a moderate power operational mode is illustrated, in accordance with an embodiment of the present disclosure. FIG. 3A is explained in conjunction with FIG. 1. The moderate power operational mode may be an optimal operational mode when the air quality conditions may be unhealthy for sensitive groups (e.g., when AQI is in a range of about 101-200). The two distinguishable regions of the bellow 111 (i.e., the first region 111A and the second region 111B) are visible through the housing 112. In the moderate power operational mode, the first region 111A and the second region 111B are equally expanded about the center of the housing 112. These equally expanded states of the first region 111A and the second region 111B about the center of the housing 112 may be used to indicate to the user that the air purifier is currently running in the moderate power operational mode.

By way of an example, the first region 111A is blue coloured and the second region 111B is green coloured. For moderate power operation mode, (i.e., AQI range between 101-200), the colour-coded feedback may be shown as green-blue because the first region 111A and the second region 111B are equally expanded about the center of the housing 112.

FIG. 3B a sectional view 300B of an exemplary air purifier in a moderate power operational mode is illustrated, in accordance with an embodiment of the present disclosure. FIG. 3B is explained in conjunction with FIGS. 1 and 3A. In the moderate power operational mode, the movable base 105 is moved towards the center of the housing 112 by the drive assembly. The first filter 108 (such as the activated carbon filter) may not be engaged in the inlet unit 114. Thus, the second filter 109 (such as the antibacterial filter), the third filter 110 (such as the true HEPA filter) and the pre-filter 113 (not shown) may be engaged in the inlet unit 114. It should be noted that the second filter 109 may be telescopically retracted around the third filter 110 (which is telescopically retracted around the pre-filter 113) inside the inlet unit 114.

When the inlet unit 114 draws in air from the outer environment, the air may be filtered through the pre-filter 113, the third filter 110, and the second filter 109. Further, the inlet unit 114 may transfer the filtered air to the airflow channel 201 due to the suction force applied by the exhaust fan 116 (not shown). The filtered air may pass through the airflow channel 201 and may reach the outlet unit 115, from where it may be released into the outer environment.

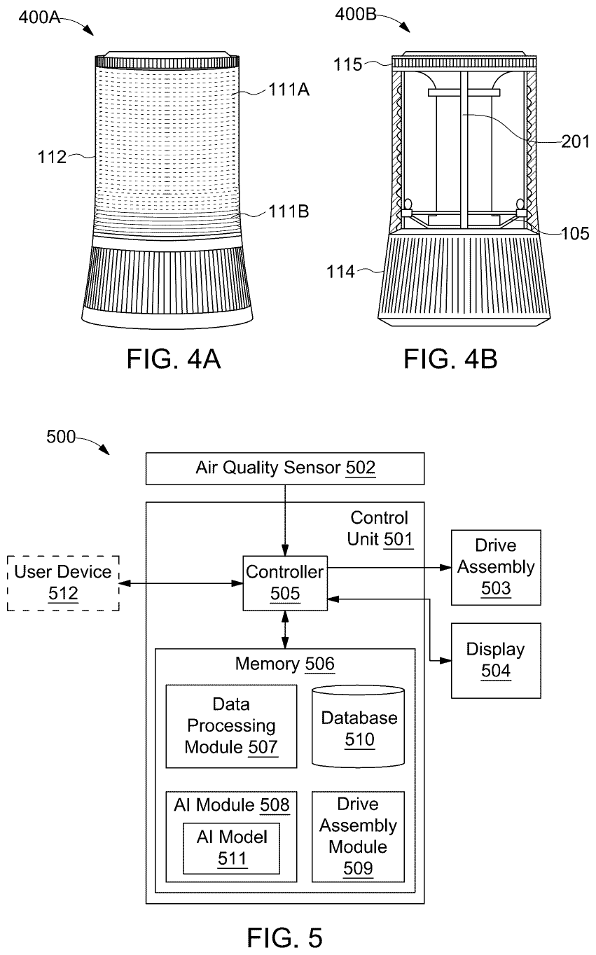

FIG. 4A a perspective view 400A of an exemplary air purifier in a high power operational mode is illustrated, in accordance with an embodiment of the present disclosure. FIG. 4A is explained in conjunction with FIG. 1. The high power operational mode may be an optimal operational mode when the air quality conditions may be very unhealthy (e.g., when AQI is in a range of about 201 and above). The two distinguishable regions of the bellow 111 (i.e., the first region 111A and the second region 111B) are visible through the housing 112. In the high power operational mode, the first region 111A is in an expanded state whereas the second region 111B is in a retracted state. These expanded and retracted states of the first region 111A and the second region 111B, respectively, may be used to indicate to the user that the air purifier is currently running in the high power operation mode.

By way of an example, the first region 111A is blue coloured and the second region 111B is green coloured. For high power operation mode, (i.e., AQI range between 0-100), the colour-coded feedback may be shown as blue because the first region 111A is in an expanded state whereas the second region 111B is in a retracted state.

FIG. 4B a sectional view 400B of an exemplary air purifier in a high power operational mode is illustrated, in accordance with an embodiment of the present disclosure. FIG. 4B is explained in conjunction with FIGS. 1 and 4A. In the high power operational mode, the movable base 105 is moved downwards by the drive assembly. Each of the set of filters may be engaged in the inlet unit 114. Thus, the first filter 108 (such as the activated carbon filter), the second filter 109 (such as the antibacterial filter), the third filter 110 (such as the true HEPA filter) and the pre-filter 113 (not shown) may be engaged in the inlet unit 114. It should be noted that the first filter 108 may be telescopically retracted around the second filter 109 (which is telescopically retracted around the third filter 110 and the pre-filter 113) inside the inlet unit 114.

When the inlet unit 114 draws in air from the outer environment, the air may be filtered through the pre-filter 113, the third filter 110, the second filter 109, and the first filter 108. Further, the inlet unit 114 may transfer the filtered air to the airflow channel 201 due to the suction force applied by the exhaust fan 116 (not shown). The filtered air may pass through the airflow channel 201 and may reach the outlet unit 115, from where it may be released into the outer environment.

Referring now to FIG. 5, a functional block diagram of an exemplary air purification system 500 is illustrated, in accordance with some embodiments of the present disclosure. FIG. 5 is explained in conjunction with FIGS. 1, 2A-B, 3A-B, and 4A-B. The air purification system 500 may be analogous to the air purifier 100. The air purification system 500 may include a control unit 501, an air quality sensor 502, a drive assembly 503, and a display 504 (analogous to the digital display 117). The control unit 501 may include a controller 505 (i.e., a processor) and a memory 506.

The 506 may store instructions that, when executed by the controller 505, may cause the controller 505 to perform air purification, in accordance with aspects of the present disclosure. The memory 506 may include a data processing module 507, an AI module 508, a drive assembly module 509, and a database 510. The AI module 508 may include an AI model 511.

The data processing module 507 may receive an input signal from the air quality sensor 502. The input signal may correspond to a current air quality level. Optionally, the data processing module 507 may perform preprocessing of the input signal. The data processing module 507 may then send the input signal to the AI module 508. process the input signal using the AI model 511 (for example, an ANN model, an RNN model, an LSTM model, a generative AI model, or the like) to determine an operation mode from a set of predefined operation modes (for example, a low power operation mode, a moderate power operation mode, and a high power operation mode).

The air purification system 500 may interact with a user via a user interface accessible via the display 504. Additionally or alternatively, the air purification system 500 may interact with the user via a user device 512. By way of an example, the user device 512 may be a remote control, a smartphone, a tablet, a laptop, a desktop, or any other electronic device. The user may manually provide the input signal corresponding to the operation mode. Based on the user-provided input signal, the operation mode may directly be implemented.

To implement the operation mode (either via AI or user selection), the drive assembly module 509 may trigger the controller 505 to cause the drive assembly to move the movable base (such as the movable base 105) along the length of the at least two vertical supports (such as the vertical support 102A and the vertical support 102B) to a predefined position corresponding to the operation mode. For example, for a low power operation mode, the predefined position of the movable base 105 may be upward in the structural frame 101.

The air purification system 500 may also include one or more external devices (not shown). In some embodiments, the control unit 501 may interact with the one or more external devices over a communication network for sending or receiving various data. The external devices may include, but may not be limited to, a remote server, a digital device, or another computing system.

It should be noted that all such aforementioned modules 507-509 may be represented as a single module or a combination of different modules. Further, as will be appreciated by those skilled in the art, each of the modules 507-509 may reside, in whole or in parts, on one device or multiple devices in communication with each other. In some embodiments, each of the modules 507-509 may be implemented as dedicated hardware circuit comprising custom application-specific integrated circuit (ASIC) or gate arrays, off-the-shelf semiconductors such as logic chips, transistors, or other discrete components. Each of the modules 507-509 may also be implemented in a programmable hardware device such as a field programmable gate array (FPGA), programmable array logic, programmable logic device, and so forth. Alternatively, each of the modules 507-509 may be implemented in software for execution by various types of processors (e.g., controller 505). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for air purification. For example, the exemplary air purification system 500 may perform air purification by the processes discussed herein. In particular, as will be appreciated by those of ordinary skill in the art, control logic and/or automated routines for performing the techniques and steps described herein may be implemented by the air purification system 500 and the associated controller 505 either by hardware, software, or combinations of hardware and software. For example, suitable code may be accessed and executed by the one or more processors on the air purification system 500 to perform some or all of the techniques described herein. Similarly, application specific integrated circuits (ASICs) configured to perform some or all of the processes described herein may be included in the one or more processors on the air purification system 500.

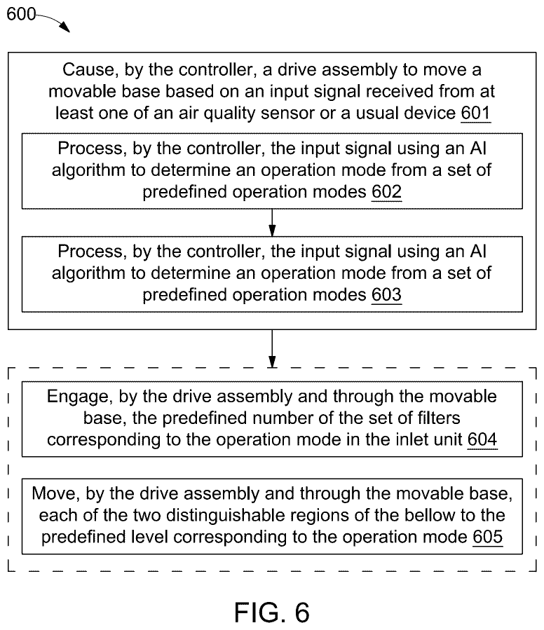

Referring now to FIG. 6, an exemplary method 600 of air purification is depicted via a flowchart, in accordance with some embodiments of the present disclosure. FIG. 6 is explained in conjunction with FIGS. 1, 2A-B, 3A-B, 4A-B, and 5. The method 600 may be implemented by the air purifier 100. The method 600 may include causing, by a controller (for example, the controller 505), a drive assembly to move a movable base (such as the movable base 105) based on an input signal received from at least one of an air quality sensor (such as the air quality sensor 502) or a user device (such as the user device 512), at step 601. The controller is communicatively coupled to the drive assembly. The drive assembly is coupled to a structural frame (such as the structural frame 101). The drive assembly is configured to move the movable base along a length of at least two vertical supports (such as the vertical support 102A and the vertical support 102B). The structural frame includes the at least two vertical supports and the movable base coupled to the at least two vertical supports.

A filter assembly including a set of filters (such as the first filter 108, the second filter 109, and the third filter 110) is arranged telescopically within the structural frame. A top filter (i.e., the topmost filter) from the set of filters is movably coupled to the movable base. A bellow (such as the bellow 111) is coupled to the movable base. The bellow includes two distinguishable regions (such as the first region 111A and the second region 111B). Each of the two distinguishable regions includes one or more unique markers (for example, colours, patterns, labels, and the like). When the movable base moves along the length of the at least two vertical supports, based on a direction of movement of the movable base, one of the two distinguishable regions is configured to expand and another of the two distinguishable regions is configured to retract.

The step 601 may include steps 602 and 603. The method 600 may include processing, by the controller, the input signal using an AI algorithm to determine an operation mode from a set of predefined operation modes, at step 602. For each of the set of predefined operation modes, a predefined number of the set of filters is engaged in the inlet unit. Additionally, for each of the set of predefined operation modes, each of the two distinguishable regions of the bellow is expanded at a predefined level. Further, based on the operation mode, the method 600 may include causing, by the controller, the drive assembly to move the movable base along the length of the at least two vertical supports, at step 603.

A housing (such as the housing 112) encloses the structural frame, the drive assembly, the filter assembly, the bellow, and the controller. The housing is at least partially transparent. The one or more unique markers of the two distinguishable regions are identifiable through the housing. An inlet unit (such as the inlet unit 114) located at a first end of the housing is configured to draw air from an outer environment. The inlet unit encloses a pre-filter (such as the pre-filter 113) and at least one of the set of filters based on a position of the movable base. An outlet unit (such as the outlet unit 115) in fluid communication with the inlet unit, is configured to receive filtered air from the inlet unit. Further, the outlet unit is configured to provide the filtered air to the outer environment.

Thereafter, the method 600 may proceed to steps 604 and 605. The steps 604 and 605 may be performed simultaneously. The method 600 may include engaging, by the drive assembly and through the movable base, the predefined number of the set of filters corresponding to the operation mode in the inlet unit, at step 604. The method 600 may include moving, by the drive assembly and through the movable base, each of the two distinguishable regions of the bellow to the predefined level corresponding to the operation mode, at step 605.

A downward movement of the movable base causes a telescopic retraction of the set of filters. The telescopic retraction increases a current number of the set of filters engaged in the inlet unit. An upward movement of the movable base causes a telescopic expansion of the set of filters. The telescopic expansion decreases a current number of the set of filters engaged in the inlet unit.

The two distinguishable regions of the bellow include a first region and a second region. A downward movement of the movable base causes an expansion of the first region and a retraction of the second region. An upward movement of the movable base causes a retraction of the first region and an expansion of the second region.

As will be also appreciated, the above described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

Thus, the disclosed smart air purifier and method thereof try to overcome the technical problem of smart and customized air purification. The air purifier is adaptable. Modular air purifiers allow users to customize the filtration system according to their specific needs. They can control the intensity of the purifier by adding or removing the filters based on the type of pollution they want to eliminate from the air. This can be especially useful for those with allergies or specific sensitivities. Further, the air purifier is cost-effective. Consumers can purchase the filters they require, rather than having to buy different air purifiers for different type of pollution or prebuilt ones. Further, the air purifier is easy to maintain. The integrated design would make it easy to replace or clean individual filters, rather than having to replace the entire unit. This also makes it easier to keep the air purifier functioning optimally, as individual filters can be maintained individually. Further, the air purifier is portable. Modular air purifiers are usually portable, making it easy for them to move from one room to another or hand carry it while on the go. This could be useful especially for those who need to address air pollution in different areas of their home or office. Further, the air purifier is versatile. The portability and customization options of a modular air purifier shall make it suitable for use in a variety of environments, including homes, offices, and vehicles. Further, the air purifier is flexible. The ability to customize the filtration system and easily move the air purifier from room to room allows consumer to use the purifier where majority of the air pollution is present. Further, the air purifier is convenient. The compact and portable design of a modular air purifier makes it easy to use and store, and the ability to replace individual filters as needed makes it more convenient to maintain.

As will be appreciated by those skilled in the art, the techniques described in the various embodiments discussed above are not routine, or conventional, or well understood in the art.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described a smart air purifier and a method thereof. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. An air purifier, comprising:
a structural frame, wherein the structural frame comprises:
at least two vertical supports; and
a movable base coupled to the at least two vertical supports;
a drive assembly coupled to the structural frame, wherein the drive assembly is configured to move the movable base along a length of the at least two vertical supports;
a filter assembly comprising a set of filters arranged telescopically within the structural frame, wherein a top filter from the set of filters is movably coupled to the movable base;
a bellow coupled to the movable base, wherein the bellow comprises two distinguishable regions, wherein each of the two distinguishable regions comprises one or more unique markers, and wherein when the movable base moves along the length of the at least two vertical supports, based on a direction of movement of the movable base, one of the two distinguishable regions is configured to expand and another of the two distinguishable regions is configured to retract; and
a controller communicatively coupled to the drive assembly, wherein the controller is configured to cause the drive assembly to move the movable base based on an input signal received from at least one of an air quality sensor or a user device.

2. The air purifier of claim 1, further comprising a housing enclosing the structural frame, the drive assembly, the filter assembly, the bellow, and the controller, wherein the housing is at least partially transparent, and wherein the one or more unique markers of the two distinguishable regions are identifiable through the housing.

3. The air purifier of claim 2, further comprising:
an inlet unit located at a first end of the housing configured to draw air from an outer environment, wherein the inlet unit encloses a pre-filter and at least one of the set of filters based on a position of the movable base; and
an outlet unit in fluid communication with the inlet unit, wherein the outlet unit is configured to:
receive filtered air from the inlet unit; and
provide the filtered air to the outer environment.

4. The air purifier of claim 3, wherein the controller is configured to:
process the input signal using an Artificial Intelligence (AI) algorithm to determine an operation mode from a set of predefined operation modes, and wherein for each of the set of predefined operation modes,
a predefined number of the set of filters is engaged in the inlet unit, and
each of the two distinguishable regions of the bellow is expanded at a predefined level;
based on the operation mode, cause the drive assembly to move the movable base along the length of the at least two vertical supports to:
engage the predefined number of the set of filters corresponding to the operation mode in the inlet unit; and
move each of the two distinguishable regions of the bellow to the predefined level corresponding to the operation mode.

5. The air purifier of claim 3, wherein:
a downward movement of the movable base causes a telescopic retraction of the set of filters,
the telescopic retraction increases a current number of the set of filters engaged in the inlet unit,
an upward movement of the movable base causes a telescopic expansion of the set of filters, and
the telescopic expansion decreases a current number of the set of filters engaged in the inlet unit.

6. The air purifier of claim 3, wherein:
the two distinguishable regions comprise a first region and a second region, a downward movement of the movable base causes:
an expansion of the first region, and
a retraction of the second region,
an upward movement of the movable base causes:
a retraction of the first region, and
an expansion of the second region.

7. The air purifier of claim 6, wherein:
the movable base comprises an inner periphery and an outer periphery,
the top filter from the set of filters is coupled to the inner periphery of the movable base, and
the bellow is coupled to the outer periphery of the movable base from a center of the bellow.

8. A method of air purification, the method comprising:
causing, by a controller, a drive assembly to move a movable base based on an input signal received from at least one of an air quality sensor or a user device, wherein:
the controller is communicatively coupled to the drive assembly,
the drive assembly is coupled to a structural frame, wherein the drive assembly is configured to move the movable base along a length of at least two vertical supports,
the structural frame comprises:
the at least two vertical supports; and
the movable base coupled to the at least two vertical supports;
a filter assembly comprising a set of filters is arranged telescopically within the structural frame,
a top filter from the set of filters is movably coupled to the movable base,
a bellow is coupled to the movable base,
the bellow comprises two distinguishable regions,
each of the two distinguishable regions comprises one or more unique markers, and
when the movable base moves along the length of the at least two vertical supports, based on a direction of movement of the movable base, one of the two distinguishable regions is configured to expand and another of the two distinguishable regions is configured to retract.

9. The method of claim 8, wherein a housing encloses the structural frame, the drive assembly, the filter assembly, the bellow, and the controller, wherein the housing is at least partially transparent, and wherein the one or more unique markers of the two distinguishable regions are identifiable through the housing.

10. The method of claim 9, wherein an inlet unit located at a first end of the housing is configured to draw air from an outer environment, wherein the inlet unit encloses a pre-filter and at least one of the set of filters based on a position of the movable base, and wherein an outlet unit in fluid communication with the inlet unit, is configured to:
receive filtered air from the inlet unit; and
provide the filtered air to the outer environment.

11. The method of claim 10, further comprising:
processing, by the controller, the input signal using an AI algorithm to determine an operation mode from a set of predefined operation modes, wherein for each of the set of predefined operation modes,
a predefined number of the set of filters is engaged in the inlet unit, and
each of the two distinguishable regions of the bellow is expanded at a predefined level; and
based on the operation mode, causing, by the controller, the drive assembly to move the movable base along the length of the at least two vertical supports to:
engage the predefined number of the set of filters corresponding to the operation mode in the inlet unit, and
move each of the two distinguishable regions of the bellow to the predefined level corresponding to the operation mode.

12. The method of claim 10, wherein:
a downward movement of the movable base causes a telescopic retraction of the set of filters,
the telescopic retraction increases a current number of the set of filters engaged in the inlet unit,
an upward movement of the movable base causes a telescopic expansion of the set of filters, and
the telescopic expansion decreases a current number of the set of filters engaged in the inlet unit.

13. The method of claim 10, wherein:
the two distinguishable regions comprise a first region and a second region, a downward movement of the movable base causes:
an expansion of the first region, and
a retraction of the second region,
an upward movement of the movable base causes:
a retraction of the first region, and
an expansion of the second region.

14. The method of claim 13, wherein:
the movable base comprises an inner periphery and an outer periphery,
the top filter from the set of filters is coupled to the inner periphery of the movable base, and
the bellow is coupled to the outer periphery of the movable base from a center of the bellow.
